(19) United States
(12) Patent Application Publication
(10) Pub. No.: US 2012/0321809 A1
(43) Pub. Date: Dec. 20, 2012

(54) SYSTEMS AND METHODS FOR MARINE ANTI-FOULING

(75) Inventors: Robert Seth Hartshorne, Cambridge (GB); Gary John Tustin, Cambridge (GB); James Francis Westwood, Surrey (GB); Steven Antony Gahlings, Cambridge (GB)

(73) Assignee: WesternGeco LLC, Houston, TX (US)

(21) Appl. No.: 13/160,934

(22) Filed: Jun. 15, 2011

(51) Int. Cl. B05D 1/02; C09D 175/00; C09D 5/16; C08G 18/83; C08G 18/00

(52) U.S. Cl. 427/427.6; 525/453; 525/452; 523/122; 525/127; 525/123

(57) ABSTRACT

An anti-biofouling material for use on marine equipment is described, the anti-biofouling material comprising a polymer system comprising a hydrophobically-modified base polymer, the hydrophobically-modified base polymer comprising a base polymer having a backbone and a hydrophobically derivatized chain extender coupled to said backbone of said base polymer, wherein the hydrophobically derivatized chain extender comprises a hydrophobic moiety. The anti-fouling casing comprises a hydrophobic surface that serves to prevent biofouling of the surface.

### BACKGROUND

The field of the invention is that of providing for the reduction of bio-fouling of marine equipment. The marine equipment may comprise oil rigs, wave power generation systems, boats, cables, anchors, chains, rudders and/or the like. Biofouling is a problematic issue for many types of marine equipment, such as boat hulls, legs and supports on oil rigs, wave power generation systems and/or the like.

Fouling of marine equipment can generate many problems:
1. drag on marine equipment that is moved through the water;
2. increase in mass of the equipment that may in turn result in damage to the equipment;
3. interference with operation of the marine equipment such as for example fouling up the operation of rudders, wave power generation systems and moving parts; and
4. cost of and risk to personnel used to remove the biofouling, which often involves deploying the personnel to manually remove the fouling organisms using scraping devices etc. The process is highly time consuming and results in economically costly lost-production time. Moreover due to the sharp nature of the hand-held devices used to physically remove fouling organisms, the process is often coupled with a likelihood of damage to the integrity of the marine equipment.

Antifouling paints have long been the most effective method to prevent macrofouling of steel-hulled marine vessels. In such paints, biocides or heavy metal compounds, such as tributyltin oxide (“TBTO”), are released (leached) from the paint to inhibit microorganism attachment. Typically these paints are composed of an acrylic polymer with tributyltin groups attached to the polymer via an ester bond. The organotin moiety has biocidal properties and is acutely toxic to the attached organisms. TBT compounds are historically the most effective compounds for biofouling prevention, affording protection for up to several years.

Unfortunately, TBT compounds are also toxic for non-target marine organisms. Furthermore, TBT compounds are not biodegradable in water and, as a result, the compounds may accumulate in water and pose an environmental hazard. As a result, the International Maritime Organization (“IMO”) banned the application of TBT compounds in 2003, and required the removal of all TBT coatings, worldwide by 2008. Alternative strategies have thus been sought that have much lower general toxicity and as such are more environmentally acceptable.

### BRIEF SUMMARY

In an embodiment of the present invention, an anti-biofouling material for use with marine equipment is described. The biofouling material comprises a hydrophobically-modified base polymer, where the base polymer may comprise a thermo-polyurethane or the like. In certain embodiments, the hydrophobically-modified base polymer may comprise a base polymer having a backbone and a hydrophobic chain extender and/or a hydrophobically derivatized chain extender coupled to said backbone of said base polymer, wherein the hydrophobic chain extender/hydrophobically derivatized chain extender comprises a hydrophobic moiety. In certain aspects of the present invention, the hydrophobic moiety comprises at least one of a fluorine derivative, a silicon derivative and a polyethylene glycol derivative.

In certain embodiments of the present invention, the polymer system comprises an (AB)ₙ type block copolymer, wherein the (AB)ₙ type block copolymer comprises a soft polyol segment and a hard segment comprising the hydrophobically-modified base polymer.

In some embodiments, the pre-polymer comprises one of polyurethane, thermoplastic polyurethane, urethane, polyvinylchloride and polyethylene and the chain extender comprises one of a fluorine derivatised chain extender, a silicone derivatised chain extender and a glycol derivatised chain extender.

In embodiments of the present invention, the anti-fouling polymer may be coupled with/to the marine equipment in many different ways. Merely by way of example, in one embodiment of the present invention, the anti-biofouling material may be heat extruded onto the marine equipment, which may for example comprise a pipe, a cable and/or the like. In another embodiment, the marine equipments may be dipped into a heated vat of the anti-biofouling material. In yet another embodiment of the present invention, the anti-biofouling material may be heat sealed/annealed onto the marine equipment. In yet a further embodiment of the present invention, the anti-biofouling material may be wrapped around the marine equipment. In such an embodiment, the anti-biofouling material may in some aspects be “tied” to the marine equipment or in other aspects, ends of the anti-biofouling material may be sealed together. In some embodiments, the anti-biofouling material/anti-fouling polymer may be injection molded so that it may form a part of a marine system and/or be formed to cover a part of a marine system. In certain embodiments, the anti-biofouling material/anti-fouling polymer may be mixed with a solvent and applied, as a spray etc. onto the marine equipment where the solvent disassociates from the anti-biofouling material/anti-fouling polymer.

In aspects of the present invention, a method of fabricating a polymer system for use for use as an anti-fouling casing is provided, the method of fabrication comprising reacting a polyol with diisocyanate to form a diisocyanate terminated intermediate oligomer and reacting the intermediate oligomer with a chain extender comprising a hydrophobic moiety.

### BRIEF DESCRIPTION OF THE DRAWINGS

In the figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The present invention will become more fully understood from the detailed description and the accompanying drawings, wherein:

FIG. 1A illustrates contact angles for effective aqueous glue attachment of an organism to a polyurethane surface;

FIG. 1B illustrates a contact angle on a polyurethane surface;

FIG. 1C; illustrates contact angles for ineffective aqueous glue attachment of an organism to a silicon coated polyurethane surface;

FIG. 2A illustrates a thermo-polyurethane (“TPU”) block copolymer;

FIG. 2B illustrates a TPU block copolymer with a hydrophobically derivatized chain extender, in accordance with an embodiment of the present invention;

FIG. 3 illustrates a method of fabricating a seismic streamer skin with a hydrophobically modified surface.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Embodiments of the invention provide an anti-biofouling material that can resist/reduce adhesion of marine organisms such as, but not limited to, biofouling by among other things marine slime, barnacles and/or the like. In some aspects, marine organisms may adhere to the anti-biofouling material, but removal of the marine organisms may be improved. In certain aspects, the anti-biofouling material is configured as a polymer that may be applied to marine equipment.

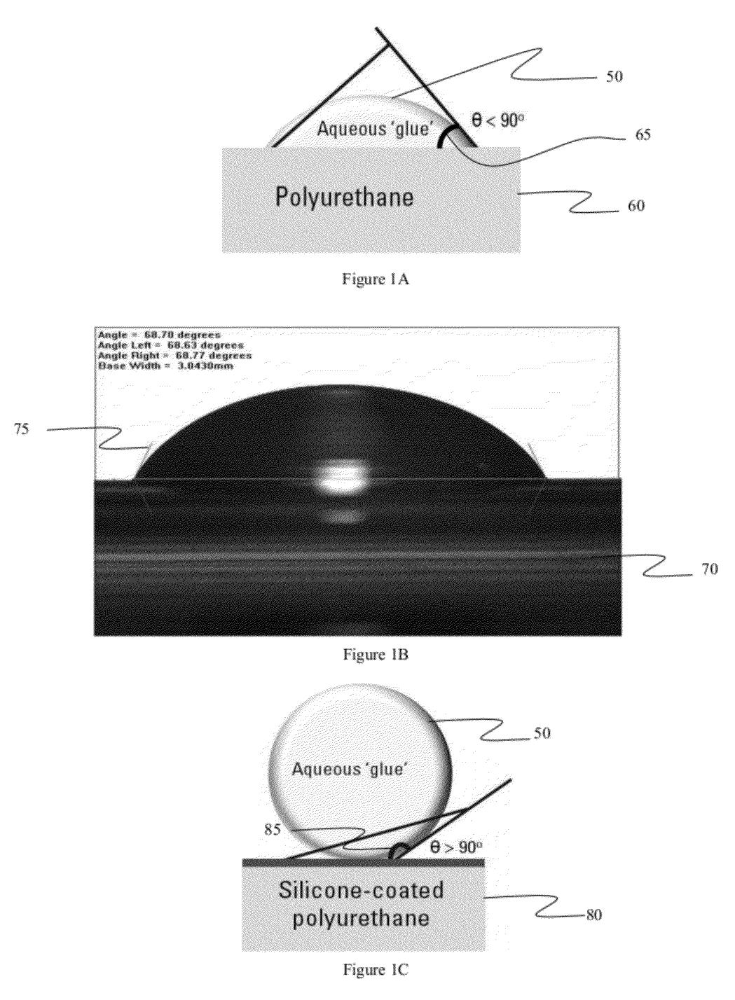

FIG. 1A is a schematic representation of how a marine organism attaches to a surface. As depicted, a barnacle (not shown) uses an aqueous glue 50 to attach to a polyurethane surface 60. The aqueous glue 50 comprises an aqueous based mixture of proteins and polysaccharides excreted by the barnacle larvae to enable adhesion. Initial adhesion is promoted by provision of a hydrophilic surface such as a typical seismic streamer surface, wherein the hydrophilic surface provides a contact angle 60 that is less than 90 degrees.

FIG. 1B illustrates a contact angle for an untreated polyurethane surface. An untreated surface 70 is relatively water wetting with a contact angle 75 of about 68.70°. As such, the untreated surface 70 is hydrophilic and prone to biofouling.

FIG. 1C is a schematic representation of how an initial attachment of marine organisms to surfaces can be reduced via provision of hydrophobic surfaces (contact angle greater than 90 degree), in accordance with an embodiment of the present invention. As provided in FIG. 1C, a treated surface 80 comprises polyurethane with a silicon coating. The silicon coating causes a contact angle 85 of the treated surface 80 to be greater than ninety (90) degrees. As a result of the contact angle 85 being greater than ninety (90) degrees a marine organism (not shown), for example a barnacle larvae, cannot adhere to the a treated surface 80 using an aqueous glue 50 comprising an excreted aqueous based mixture of proteins and polysaccharides.

Changes to the contact angle of the skin of the surface may be produced by applying a coating. A large change in the contact angles was observed with the application of a silicone coating, such as an aminoalkyl functionalized polydimethylsiloxane. However, such a silicone coating may be very difficult to apply to marine equipment due to the contrast in the chemical nature of the coating and the material of the marine equipment. Furthermore, it may be problematic applying anti-biofouling materials to marine equipment because of the erosion of the materials by sea water, the degradation of the materials over time, the processes for coupling the material with the marine equipment.

In some embodiments, polymers such as for example TPU may be used as a base structure to provide a versatile anti-fouling material that can be coupled with marine equipment and, among other things, address such issues as erosion and breakdown. TPU is formed by the reaction of: (1) diisocyanates with short-chain diols, referred to as chain extenders and (2) diisocyanates with long-chain bifunctional diols (known as polyols). The virtually unlimited amount of possible combinations for varying the structure and/or molecular weight of the three reaction compounds make it possible to fabricate an enormous variety of different TPUs.

TPU resin consists of linear polymeric chains in block-structures, where the linear chains contain low polarity segments, called soft segments, and are alternated in the resin with shorter, high polarity segments called hard segments. Both types of segments are linked together/coupled by covalent links/bonds to form block-copolymers.

The polarity of the hard segments creates a strong attraction between the hard segments, which causes a high degree of aggregation and order in the hard segment phase of the TPU. As such, the hard segment phase forms crystalline or pseudo crystalline areas that are disposed in a soft and flexible matrix. The crystalline or pseudo crystalline areas of the hard phase of the block copolymer act as physical crosslinks providing for the high elasticity level of TPU, whereas the flexible chains provide the elongation characteristics to the polymer. It is this combination of properties of the TPU block copolymer system that make it desirable for use in seismic streamers.

As discussed above, thermoplastic polyurethanes are a versatile group of multi-phase segmented polymers that have excellent mechanical and elastic properties, good hardness and high abrasion and chemical resistance. Generally, polyurethane block copolymers are comprised of a low glass transition or low melting ‘soft’ segment and a rigid ‘hard segment’, which often has a glassy Tg or crystalline melting point well above room temperature.

For some embodiments, the soft segment may comprise a dihydroxy terminated long chain macroglycol with a molecular weight between 500-5000 grammes per mole, though in practice, molecular weights of 1000 and 2000 grammes per mole, are primarily used. They include polyethers, polyesters, polydienes or polyolefins. The hard segment normally includes the reaction product of a disocyanate (aliphatic or aromatic) and a low-molecular weight diol or diamine (referred to as a ‘chain extender’). The role of the chain extender will be discussed further below. The combination of this soft polyol segment and hard segment forms an (AB)ₙ type block copolymer.

Polyurethane elastomers usually exhibit a two-phase microstructure. The microphase separation, or microdomain formation, results in superior physical and mechanical properties. The degree of separation or domain formation depends on the weight ratio of the hard to soft segment, the type and molecular weight of the soft segment, the hydrogen bond formation between the urethane linkages and the manufacturing process and reaction conditions, including the addition/use of catalysts. A further key component that may be used to tune the microdomain formation, and thus the final properties of the polyurethane block copolymer, is the role performed by the chain extender.

In the most common method of polyurethane production, i.e. via a two-step synthesis, or ‘pre-polymer’ route, the polyol is initially reacted with excess diisocyanate to form a diisocyanate terminated intermediate oligomer. The prepolymer is typically a viscous liquid or low melting point solid. The second step is to convert this prepolymer to the final high molecular weight polyurethane by further reaction with a low molecular weight diol chain extender—for example 1,4-butanediol, 1,6-hexanediol—or a diamine chain extender—for example ethylene diamine, 4,4′-methylene bis(2-chloroaniline). This step is generally referred to as chain extension.

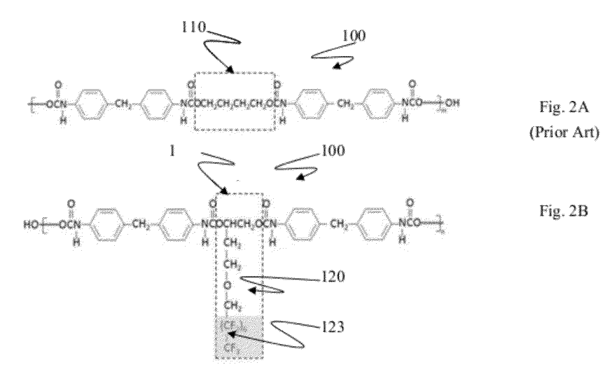

FIG. 2A illustrates a TPU block copolymer as discussed above. As depicted, a TPU block copolymer 100 comprises a backbone 110. In a conventional seismic streamer skin, a chain extender (not shown) may be coupled with the backbone of the TPU block copolymer 100. The chain extender may comprise a diol or a diamine chain extender. In the absence of a chain extender, a polyurethane formed by directly reacting diisocyanate and polyol generally has very poor physical properties and often does not exhibit microphase separation. Thus, the introduction of the chain extender in a conventional seismic streamer skin material can increase the hard segment length of the material to permit hard segment segregation, which results in modified mechanical properties, such as an increase in the hard segment glass transition temperature (Tg) of the polymer.

FIG. 2B illustrates a TPU block copolymer with a hydrophobically derivatized chain extender, in accordance with an embodiment of the present invention. In accordance with an embodiment of the present invention, a hydrophobically derivatised chain extender 120 is coupled with the backbone 110 of the TPU block copolymer 100. In certain embodiments of the present invention, the hydrophobically derivatised chain extender 120 may comprise a fluorinated or silicone derivatised species chosen from either of the two categorized main classes; namely the aromatic diol and diamine classes, and the corresponding aliphatic diol and diamine classes.

In FIG. 2B, in accordance with one embodiment of the present invention, the hydrophobically derivatised chain extender 120 comprises fluorine moieties 123. In other aspects of the present invention, the derivatised chain extender 120 may comprise other hydrophobic moieties, such as silicon or the like.

In some embodiments, other methods of incorporating the hydrophobic moiety into the PU backbone may be used. In such embodiments, rather than using a hydrophobically modified chain-extender, a portion of the initial polyol is substituted for a hydrophobically-modified variant to generate a hydrophobically modified ‘prepolymer’. The prepolymer is then subsequently reacted with a normal chain extender rather than a hydrophobically derivatised version. Merely by way of example, such methods may be used for hydrophobically modified prepolymers that are modified with fluorine, silicone and/or the like. In the case of silicon, a Silmer/Fluorolink pre-polymer may be used to produce a TPU with an attached hydrophobic moiety.

In an embodiment of the present invention using a hydrophobically modified chain-extender, to incorporate a fluorine moiety into the TPU backbone, a fluorinated chain extender may be used. These chain extenders are commercially available and may comprise perfluoroether diols or the like. In certain aspects of the present invention, the chemistry used for attaching the fluorinated chain extenders may be based on two monomers, namely hexafluoropropene or tetrafluoroethylene.

In other embodiments of the present invention, to incorporate silicone onto the TPU backbone, a siloxane chain extender is used. Merely by way of example, 1,3-bis(4-hydroxybutyl)-1,1,3,3-tetramethyldisiloxane and 1,3-bis(4-aminopropyl)-1,1,3,3-tetramethyldisiloxane may be used to yield a TPU that comprises siloxane chain extenders coupled with the backbone of the TPU.

In yet other embodiments of the present invention, rather than using a fluorine or silicone derivatised chain extender to yield a polyurethane/TPU with hydrophobic surface properties, a chain extender may be utilized that is chosen from the polyethylene glycol (“PEG”) family. PEG molecules are hydrophobic and, as such, in aspects of the present invention the use of relatively low molecular weight (100-10,000 grammes per mole) PEG molecules—such as amine terminated PEGs, alcohol terminated PEGs and/or the like—as chain extenders provide for a TPU material that may be used to produce a streamer skin having surface anti-fouling properties.

The use of hydrophobic chain extenders in polyurethane has a limit with regard to the amount of hydrophobic modification that can be achieved. As such, in some embodiments of the present invention, to enhance the amount of hydrophobicity within the TPU polymer system, the hydrophobic chain extenders may be used in conjunction with a filler configured to increase the hydrophobic properties of the TPU and, as a consequence, make the material more resistant to bio-fouling. In aspects of the present invention, the fillers may comprise relatively high molecular weight hydrophobic polymers, typically in a solid form that can be blended or mixed with the hydrophobically modified polyurethane. Merely by way of example, hydrophobic additives that may be used in conjunction with a hydrophobically modified TPU, in accordance with an embodiment of the present invention, include polyethylene, polyisobutylene or polystyrene.

Merely by way of example, in one embodiment of the present invention, a hydrophobically modified polyurethane—which may be hydrophobically modified by linking the TPU backbone with chain extenders containing silicone moieties, fluorine a moieties and/or the like—may be blended with polytetrafluoroethylene (“PTFE”) or polydimethylsiloxane (“PDMS”) granules/pellets. In certain aspects, the PTFE may a micronized PTFE, which is commercially available.

In some aspects of the present invention, the hydrophobic additive may be blended with the hydrophobically modified TPU base material during a melt processing stage. The mixture may then be heated and extruded into pellets. In an embodiment of the present invention, the pellets may be heat extruded to form the streamer skin. The pellets may, in some aspects of the present invention, be extruded directly onto marine equipment such as a cable, pipe or the like. In other aspects of the present invention, the pellets may be extruded to form a section of anti-biofouling material of desired specifications, i.e. outer diameter, outer width, inner diameter, inner width, length etc. By creating a section of anti-biofouling material of desired dimensions, the marine equipment may be inserted into the anti-biofouling section post extrusion. In some aspects of the present invention, the pellets may be co-extruded with pellets of unmodified TPU to provide a material having hydrophobic properties that differ across the skins diameter. In some embodiments of the present invention, the filler material is selected to produce a material that, among other things, is more durable, has anti-fouling properties and provides an increased resistance to physical damage such as wear or abrasion.

In some embodiments of the present invention, the molecular additive is a solid. In other embodiments of the present invention, the molecular additive is a liquid that may be introduced into the melt processing stage via a preliminary stage. Merely by way example, the preliminary stage may comprise coating a TPU base material with the liquid molecular additive and then drying the coated TPU base material. The coated TPU base material may then be melted, extruded and pelleted. The produced pellets may then be blended with unmodified TPU to generate a modified TPU with increased wear-resistance and/or hydrophobic properties. Thus, embodiments of the present invention, provide that liquid-based additives, such as silicone, fluoro polymers or fluorosilicone containing species may be used as molecular additives that may be used with the hydrophobically modified TPU.

In an embodiment of the present invention, the hydrophobically modified TPU can be used as the polyurethane master batch to produce anti-fouling material. As, for example, fluorine/silicone or the like, is dispersed throughout the TPU master batch, following the production process, a material is produced which yields a hydrophobic, low-energy surface. The incorporation of hydrophobic derivatised chain-extenders, such as fluorine or silicon derivatised chain extenders, into the polyurethane synthesis reaction will thus impart a change in the surface chemistry upon the thermoplastic polyurethane such that it is less water-wetting than its non-modified counterpart. In an embodiment of the present invention, this change in the surface wettability makes the resulting surface of the material less susceptible to bio-fouling.

In embodiments of the present invention, the anti-biofouling material may also comprise biocidal additives in addition to the antifouling additives. In certain aspects, the biocide may take the form of, but is not limited to, nanoparticles of silver, copper oxide or zinc oxide, quaternary ammonium salts and organic species, such as benzoic acid, tannic acid or capsaicin. In an embodiment of the present invention, the biocide may be blended with the antifouling additives prior to blending with the base material. In other embodiments, the biocidal materials may be coated on the anti-biofouling material, which material includes the hydrophobically modified chain extenders. The biocidal elements may prevent the build-up of marine species, including micro-foulers (which are food sources for the macrofoulers), on the anti-biofouling material.

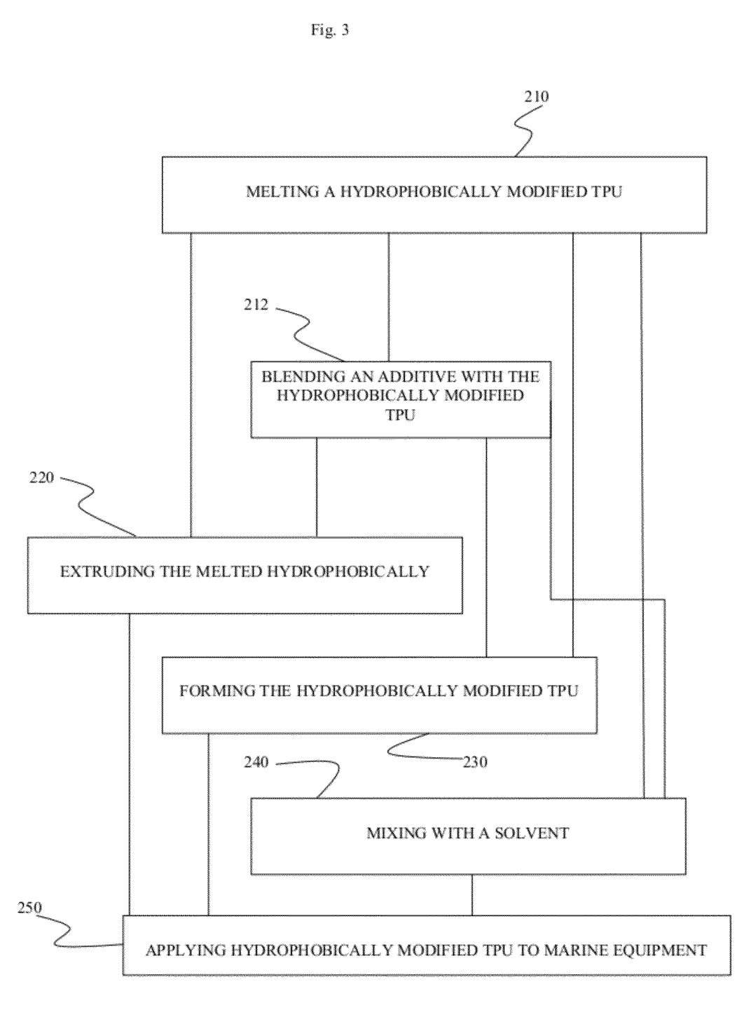

FIG. 3 illustrates methods of preparing anti-biofouling material for application with marine equipment, in accordance with certain embodiments of the present invention. In 210, steps may be taken to melt the anti-biofouling material, which may comprise the hydrophobically modified TPU, as discussed herein. In 212, steps may be taken to blend an additive, such as a biocide with the melted anti-biofouling material. This may provide for dispersal of the biocide throughout the anti-biofouling material.

In 220, steps may be taken to extrude the molten anti-biofouling material. Extrusion may comprise extruding the anti-biofouling material onto marine equipment, such as a pipe or a cable. In other aspects, the molten anti-biofouling material may be extruded into shape that may be fitted over the marine equipment. Alternatively, the marine equipment may be dipped in the molten anti-biofouling material.

In 230 steps may be taken to form the molten anti-biofouling material into a desired section/shape. Merely by way of example, the molten anti-biofouling material may be formed into sections/shapes, such as panels or the like, and cooled down. Depending on the composition of the anti-biofouling material, in some aspects the section/shapes may be rigid when cooled down and other compositions may provide for some flexibility of the anti-biofouling material upon cooling. In certain aspects of the present invention, the molten anti-biofouling material may be injection molded into a desired shape.

In 240 steps may be taken to mix the anti-biofouling material with a solvent. This mixing may create a liquid/fluid form of the anti-biofouling material. In 250, steps may be taken to apply the anti-biofouling material to marine equipment. Merely by way of example, the liquid formed from the anti-biofouling material and the solvent may be sprayed onto the marine equipment. In other embodiments, sections, injection molded shapes, extruded shapes of the anti-biofouling material may be applied to the marine equipment.

In one aspect, the anti-biofouling material of the present invention may be applied to marine cables. In such aspects, the anti-biofouling material of the present invention may be extruded onto the cable. In other aspects the anti-biofouling material of the present invention, may be wrapped around the cable.

In some embodiments of the present invention, marine equipment made from TPU a polymer and/or the like may have the anti-biofouling material of the present invention attached to it using heat curing or the like. In other embodiments of the present invention, marine seismic equipment or portions of such equipment may have the anti-biofouling material of the present invention deposited on them by dipping the equipment or portions of the equipment into a molten vat of the anti-biofouling material of the present invention. In some embodiments, heated amounts of the anti-biofouling material of the present invention, may be contacted with and sealed to the marine equipment or portions thereof. In various embodiments, the anti-biofouling material of the present invention may be extruded into shapes configured to envelop marine equipment or a portion thereof. In certain embodiments, sections of the anti-biofouling material of the present invention may be produced and this sections may be heat sealed to marine equipment or may be wrapped around the marine equipment. For example, a section of the anti-biofouling material of the present invention may be wrapped around the leg of an oil rig, a rudder of a boat and/or the like. The anti-biofouling material of the present invention may be secured to marine equipment by tying or may be sealed together using a heating process.

Where marine equipment is made from plastic, polymer, TPU and/or the like or already comprises a coating or layer of such material, the plastic polymer, TPU and/or the like may be heated, or at least an outer layer may be heated, and then contacted with a heated section of the anti-biofouling material of the present invention. The heating may provide for cross-linking, sealing, adhering and/or the like of the marine equipment and the anti-biofouling material of the present invention.

Polyurethane coatings: Polyurethane coatings can be both one-component (moisture cured) or two-component. Two-component polyurethanes are among the most versatile coating types. They provide a high-performance cover over metal, concrete, wood and plastic. Polyurethanes are mainly used as topcoats in an epoxy paint systems. They can be applied by brushes or sprayed on and the drying time and curing time is dependent upon the chemistry and temperature it is dried under. They can also be combined with other materials such as epoxy resins to tune the properties of the coating. In certain embodiments, the polyurethane of the present invention may be mixed with a solvent and applied by spraying the solvent mixture onto a marine article to be coated.

Casting: Polyurethane melts can be molded to provide structures that are pliable and can be readily applied as over-shields for structures such as wave power structures and to the legs of drilling platforms. As such they can be removed and replaced with a new structure when they have reached the end of their life span. Polyurethane sheets, hoses etc. are readily made using the casting/extraction process.

Extrusion: Polyurethane can be extruded over pipes or other regular structures. Use the patent on co-extrusion to give an over-layer on the streamer. These may need a tie layer to help adhesion.

While the principles of the disclosure have been described above in connection with specific apparatuses and methods, it is to be clearly understood that this description is made only by way of example and not as limitation on the scope of the invention.

What is claimed is:

1. An anti-biofouling material for use on marine equipment, comprising:
a polymer system comprising a hydrophobically-modified base polymer, wherein the hydrophobically-modified base polymer comprises a base polymer having a backbone and a hydrophobically derivatized chain extender coupled to said backbone of said base polymer.

2. The anti-biofouling material of claim 1, wherein the hydrophobically derivatized chain extender comprises a hydrophobic moiety.

3. The anti-biofouling material of claim 2, wherein the hydrophobic moiety comprises at least one of a fluorine derivative, a silicon derivative and a polyethylene glycol derivative.

4. The anti-biofouling material of claim 1, wherein the base polymer comprises one of polyurethane, thermoplastic polyurethane, urethane, polyvinylchloride and polyethylene.

5. The anti-biofouling material of claim 1, wherein the polymer system comprises an (AB)ₙ type block copolymer, and wherein the (AB)ₙ type block copolymer comprises a soft polyol segment and a hard segment comprising the hydrophobically-modified base polymer.

6. The anti-biofouling material of claim 5, wherein the (AB)ₙ type block copolymer has a two-phase microstructure.

7. The anti-biofouling material of claim 5, wherein the soft polyol segment comprises a dihydroxy terminated long chain macroglycol.

8. The anti-biofouling material of claim 1, further comprising a biocide.

9. The anti-biofouling material of claim 1, further comprising a hydrophobic polymer filler.

10. The anti-biofouling material of claim 9, wherein the hydrophobic polymer filler comprises at least one of polytetrafluoroethylene, polydimethylsiloxane and polyethylene, polyisobutylene and polystyrene.

11. The anti-biofouling material of claim 1, wherein the hydrophobically-modified base polymer is produced by reacting a pre-polymer with the hydrophobically derivatized chain extender.

12. The anti-biofouling material of claim 11, wherein:
the pre-polymer comprises one of polyurethane, thermoplastic polyurethane, urethane, polyvinylchloride and polyethylene.

13. The anti-biofouling material of claim 1, wherein the hydrophobically-modified base polymer is produced by a method comprising:
substituting a portion of an initial polyol with a hydrophobically-modified variant or derivative to produce a hydrophobically modified prepolymer; and
reacting the hydrophobically modified prepolymer with a chain extender to produce the hydrophobically-modified base polymer.

14. The anti-biofouling material of claim 9, wherein the hydrophobic polymer filler is homogeneously dispersed throughout the anti-biofouling material.

15. A method of applying the anti-biofouling material according to claim 1 to marine equipment, comprising:
extruding the anti-biofouling casing as a tube; and
inserting the marine equipment into the extruded tube of the anti-biofouling material.

16. The method of claim 17, wherein the marine equipment comprises a cable.

18. A method of applying the anti-biofouling material according to claim 1 to marine equipment, comprising:
extruding the anti-biofouling material onto an outer-surface of the marine equipment.

19. A method of applying the anti-biofouling material according to claim 1 to marine equipment, comprising:
heat sealing the anti-biofouling material with an outer-surface of the marine equipment.

20. A method of applying the anti-biofouling material according to claim 1 to marine equipment, comprising:
wrapping the anti-biofouling material around an outer-surface of the marine equipment.

21. A method of applying the anti-biofouling material according to claim 1 to marine equipment, comprising:
dipping at least a portion of the marine equipment into a molten vat of the anti-biofouling material.

22. A method of applying the anti-biofouling material according to claim 1 to marine equipment, comprising:
mixing the anti-fouling material with a solvent; and
spraying the solvent mixture onto the marine equipment.

23. A material for applying to marine equipment to prevent biofouling of said equipment, comprising:
a hydrophobically-modified base polymer.

24. The material of claim 23, wherein the hydrophobically-modified base polymer comprises a thermo-polyurethane.

25. The material of claim 23, wherein the hydrophobically-modified base polymer comprises a thermo-polyurethane backbone coupled to chain extenders.

26. The material of claim 25, wherein the chain extender is selected from a group consisting of a fluorine derivatised chain extender, a silicone derivatised chain extender and a glycol derivatised chain extender.

27. The material of claim 23, wherein the hydrophobically-modified base polymer comprises a polyol in which a portion of the polyol is substituted for a hydrophobically-modified variant to generate a hydrophobically modified prepolymer and the prepolymer is coupled with a chain extender.
